(19) United States
(12) Patent Application Publication
(10) Pub. No.: US 2021/0188374 A1
(43) Pub. Date: Jun. 24, 2021

(54) Tractor Hydraulic Adapter and Process

(71) Applicant: Brian J. Hollis, Gainsville, GA (US)

(72) Inventor: Brian J. Hollis, Gainsville, GA (US)

(21) Appl. No.: 17/129,919

(22) Filed: Dec. 22, 2020

Related U.S. Application Data
(60) Provisional application No. 62/953,444, filed on Dec. 24, 2019.

(51) Int. Cl. B62D 49/00; B60K 17/28; B60K 17/356; B62D 49/02; B62D 49/06

(52) U.S. Cl. CPC B62D 49/002; B60K 17/28; B62D 49/0621; B62D 49/02; B60K 17/356

(57) ABSTRACT

A tractor hydraulic adaptor, system and process to hydraulically power a hydraulic attachment on a tractor is disclosed. The hydraulic adapter includes a hydraulic intensifier powered by a tractor's power take off shaft to drive a hydraulic attachment coupled to a tractor's front-end loader. The hydraulic intensifier draws at a low-pressure hydraulic fluid and feeds the hydraulic fluid at a higher pressure to the hydraulic attachment.

### TECHNICAL FIELD

These claimed embodiments relate to a tractor hydraulic adapter and more particularly to attaching a hydraulic adapter to a power take off (PTO) on a rear of a tractor to control hydraulically operated devices connected to the front of a tractor.

### BACKGROUND OF THE INVENTION

A method and apparatus for hydraulically powering one or more hydraulically powered devices on a front of a tractor that is powered by a tractor PTO disposed on a rear of a tractor is disclosed.

Hydraulically powered tools such as an auger brush cutter, a street sweeper, a snow blower, a trencher, or a stump grinder are typically used on the front of a skid steer. Tractors are powered by an engine running a power takeoff shaft, that typically rotates at 1000 revolutions per minute (rpm) to directly power a cutter or shaft powered device disposed on the rear of the tractor. Shaft powered devices are susceptible to breakage if the cutter attempts to cut an object beyond the cutter's capability resulting in breakage of the cutting implement or damage to the shaft. Further such cutters must be disposed on the rear of the tractor so that the pto can directly power the cutter.

### SUMMARY OF THE INVENTION

In one implementation a tractor hydraulic adaptor is disclosed. The adaptor includes a hydraulic tank operative to store hydraulic fluid, a hydraulic pump having a pump shaft adapted to couple with a tractor power take off (PTO) shaft disposed on a rear of the tractor, the pump shaft turning in response to rotation of the tractor PTO shaft to run the hydraulic pump. The hydraulic pump includes a hydraulic intensifier coupled with the hydraulic tank to draw stored hydraulic fluid from the tank at a low pressure and feed via a valve block the drawn hydraulic fluid at a high pressure to a hydraulic attachment disposed on a front of the tractor. The adapter further includes a heat exchanger to cool hydraulic fluid returned from the hydraulic attachment via the valve block and maintain the hydraulic fluid temperature within a predetermined range, and a hydraulic filter coupled to the heat exchanger and the hydraulic tank, the hydraulic filter to filter contaminants from the hydraulic fluid cooled by the heat exchanger and to deposit filtered fluid into the hydraulic tank. Preferably, the hydraulic pump includes a through shaft coupled with an alternator to provide electric power to the heat exchanger.

In another implementation, a method for hydraulically controlling a hydraulic attachment with a hydraulic adapter powered by a tractor power take off (PTO) shaft disposed on a rear of a tractor is disclosed. The method includes providing within the hydraulic adapter a hydraulic intensifier pump fluidly coupled to a valve block and a hydraulic tank, a heat exchanger fluidly coupled to the valve block and coupled to the hydraulic tank via a hydraulic filter. The hydraulic adapter is physically attached to a hitch on a rear portion of the tractor such that the PTO shaft rotatably couples with a pump shaft of the hydraulic intensifier pump. The hydraulic attachment is physically coupled to a front portion of the tractor. The hydraulic attachment is fluidly coupled to the valve block. The pump shaft is rotated in response to rotation of the PTO shaft to run the hydraulic intensifier pump. The hydraulic intensifier pump draws at a low-pressure hydraulic fluid stored in the hydraulic tank and feeds via the valve block the drawn hydraulic fluid at a higher pressure to the hydraulic attachment. The hydraulic attachment is operated with the pressurized fluid from the valve block, and returning the fluid to the valve block. The hydraulic fluid returned from the hydraulic attachment via the valve block is cooled with a heat exchanger to maintain the hydraulic fluid temperature within a predetermined range. The hydraulic filter filters contaminants from the hydraulic fluid cooled by the heat exchanger. The filtered fluid is deposited into the hydraulic tank.

In addition, a system is included having a tractor with a rear power take off (PTO) shaft and a hydraulic attachment coupled a tractor front end loader. A hydraulic adapter containing a hydraulic intensifier powered by the PTO shaft to drive the hydraulic attachment disposed on a front of the tractor. The hydraulic intensifier operative to draw at a low-pressure hydraulic fluid and feed the drawn hydraulic fluid at a higher pressure to the hydraulic attachment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a perspective diagram of a hydraulic adapter powered by a tractor and connected to a skid steer device on the tractor front:

FIG. 2 is a simplified schematic diagram of the hydraulic adapter that provides hydraulics to a control a skid steer device;

FIG. 3 is a flow chart of a process to control a skid steer attachment on a tractor with the hydraulic adapter shown in FIG. 1;

FIG. 4 is a diagram of a front view of the hydraulic adapter;

FIG. 5 is a diagram of a right-side view of the hydraulic adapter;

FIG. 6 is a diagram of a left side view of the hydraulic adapter;

FIG. 7 is a diagram of a right front view of the hydraulic adapter with a hydraulic filter exposed; and

FIG. 8 is a diagram of a left rear view of the hydraulic adapter with a pump, a Saturn valve, a heat exchange fan and a hydraulic tank exposed.

### DETAILED DESCRIPTION

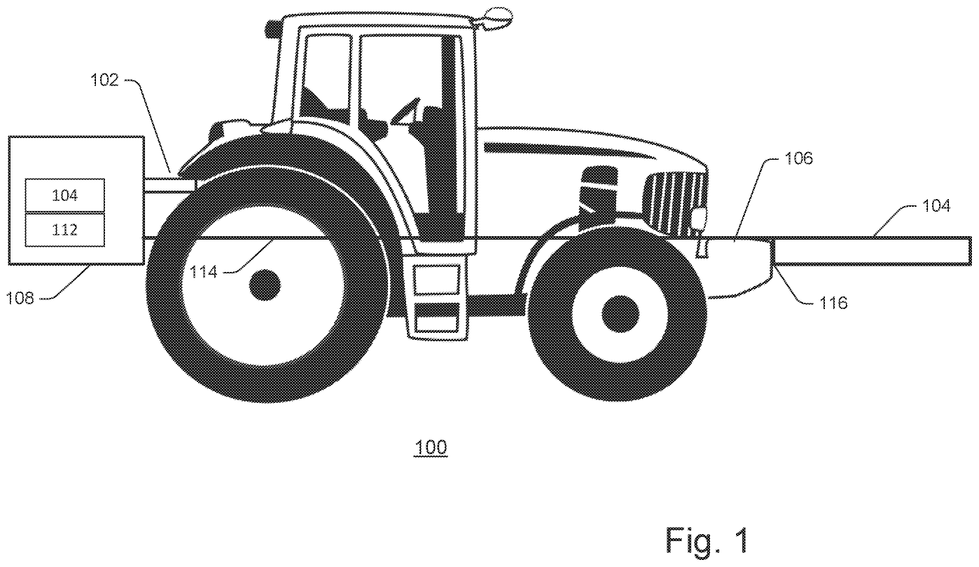

Referring to FIG. 1 there is shown a tractor 100 with a rear power take off (PTO) shaft 102 and a hydraulic attachment 104 coupled a tractor front end loader 106.

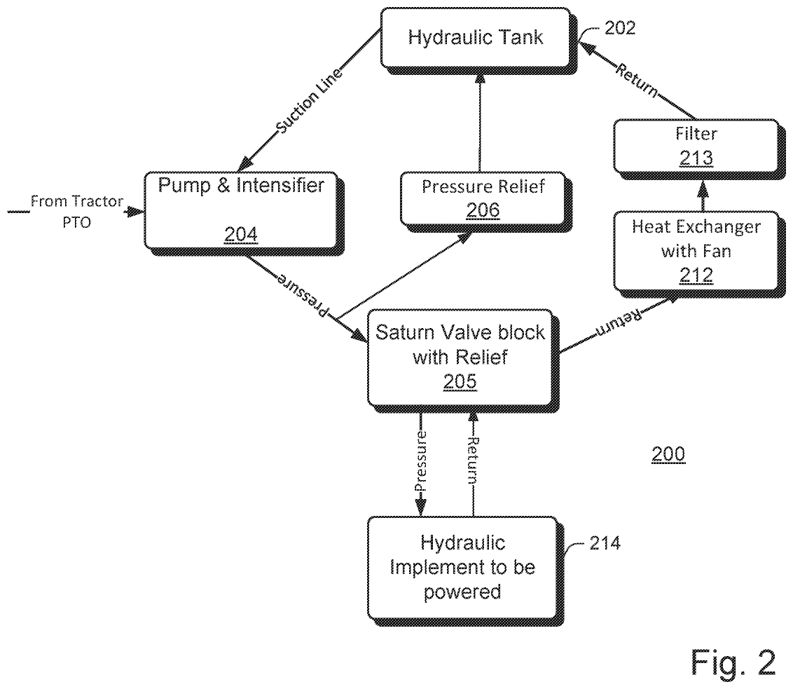

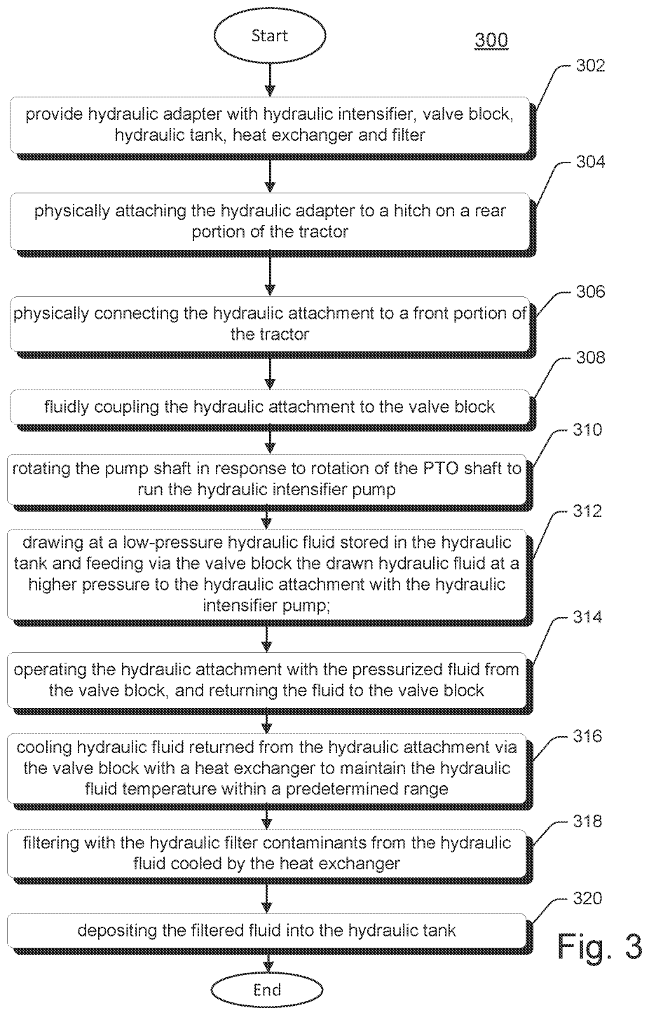

A hydraulic adapter 108 containing a hydraulic pump 110 is powered by the PTO shaft 102 to drive the hydraulic attachment 104. The hydraulic power operative to draw hydraulic fluid from a fluid tank 112 in the adapter 108. The drawn hydraulic fluid is fed to the hydraulic attachment 104 on a front of the tractor 100 via a hydraulic line 114 extending along the length of the tractor 100. Further details of the hydraulic adapter 108 are disclosed in connection with FIGS. 2-3.

The hydraulic attachment 104 may be an auger, a brush cutter, a trencher, a stump grinder, a snow blow or a street sweeper. In one implementation, the hydraulic attachment 104 is coupled to a skid steer receiver 116 on a tractor front end loader 118.

Referring to FIG. 2, there is shown a tractor hydraulic adaptor 200 (hydraulic adapter 108 of FIG. 1). The tractor hydraulic adapter 200 includes a hydraulic tank 202, pump 204, Saturn valve block 205 coupled to relief 206, heat exchanger 212 with a fan and filter 213.

Hydraulic tank 202 stores hydraulic fluid. The tank 202 is connected via a suction line 203 to a hydraulic pump 204 with an intensifier (referred to herein as “pump 204”). Pump 204 includes a pump shaft that couples (using a shaft adapter) with the tractor power take off (PTO) shaft disposed on a rear of the tractor 100. The pump shaft turns in response to rotation of the tractor PTO shaft to run the hydraulic pump 204. The hydraulic pump 204 draws stored hydraulic fluid from the tank 202 at a low pressure via line 203. Pump 204 feeds via the valve block 205 and a hydraulic line 215 the drawn hydraulic fluid at a high pressure to a hydraulic attachment 214 disposed on a front of the tractor 100. In one implementation, pump 204 is an multiplier (or intensifier) type rotating hydraulic pump, such that the pressure of the hydraulic fluid can be increased and or decrease in response to the tractor increasing or decreasing the number of revolutions per minute of rotation of the PTO shaft. Relief 206 opens when pressure of fluid from pump exceeds a predetermined threshold and deposits the fluid into tank 210.

The hydraulic fluid is feed via the valve block 205 at a high pressure a hydraulic attachment 214 disposed on a front of the tractor or the tractor front end loader. Attachment 214 may include an auger, a brush cutter, a snow blower, a trencher, a stump grinder, or a street sweeper.

Heat exchanger 212 cools hydraulic fluid returned from the hydraulic attachment 214 via the valve block 205 and maintains the hydraulic fluid temperature within a predetermined range. The heat exchanger 212 may be electrically powered via electric power provided by a generator on the tractor 100 or may be powered by an alternator (not shown) coupled with the PTO shaft, or a feed through shaft exiting the pump 204.

Hydraulic filter 213 is coupled to the heat exchanger 212 and the hydraulic tank 210. The hydraulic filter 213 filters contaminants from the hydraulic fluid cooled by the heat exchanger 212 and deposits filtered fluid into the hydraulic tank 210.

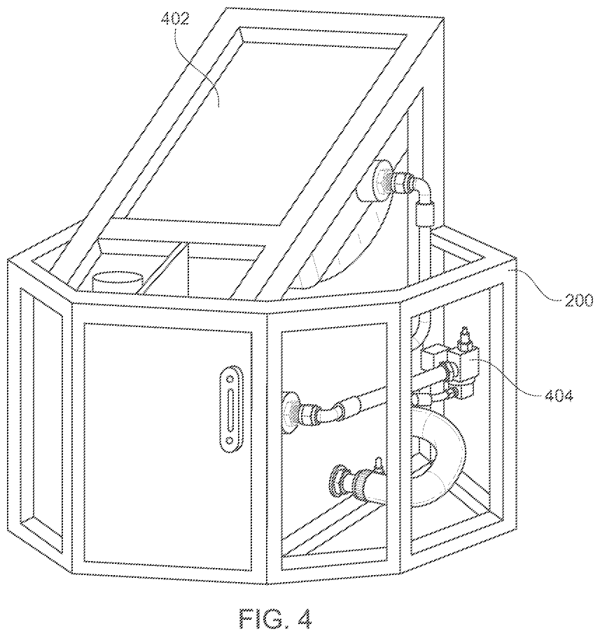

Referring to FIG. 3, there is described a process 300 for hydraulically controlling a hydraulic attachment 104 with a hydraulic adapter (hydraulic adapter 108 of FIG. 1) powered by a tractor PTO shaft 102 extending out the rear of a tractor 100. The exemplary process in FIG. 4 is illustrated as a collection of blocks in a logical flow diagram, which represents a sequence of operations that can be implemented in with a tractor 100. The order in which the operations are described is not intended to be construed as a limitation, and any number of the described blocks can be combined in any order and/or in parallel to implement the process. For discussion purposes, the processes are described with reference to FIG. 3, although it may be implemented in other system architectures

Referring to FIG. 3, a process 300 is shown for hydraulically controlling a hydraulic attachment 104 with a hydraulic adapter 214 using the devices shown in FIGS. 1-2.

In block 302, the hydraulic adapter 200 (FIG. 2) is provided. As shown in FIG. 2, the hydraulic adapter 200 includes a hydraulic intensifier pump 204 fluidly coupled to a valve block 205 and a hydraulic tank 202, a heat exchanger 212 fluidly coupled to the valve block 205 and coupled to the hydraulic tank 202 via a hydraulic filter 213.

In block 304, the hydraulic adapter 200 is physically attached to a hitch on a rear portion of the tractor 100 such that the tractors PTO shaft rotatably couples with a pump shaft of the hydraulic intensifier pump 204.

In block 306, the hydraulic attachment 200 is physically connected to a front portion of the tractor 100.

In block 308, the hydraulic attachment 214 is fluidly coupled to the valve block 205.

In block 310, the pump shaft is rotated in response to rotation of the PTO shaft on the tractor 100 to drive the hydraulic intensifier pump 204.

In block 312, hydraulic fluid stored in the hydraulic tank 202 is drawn at a low temperature and feed via the valve block 205 the drawn hydraulic fluid at a high pressure to the hydraulic attachment 214 by the hydraulic pump 204. The drawn (high pressure) hydraulic fluid is fed through a hydraulic fluid line extending from a back of the tractor 100 to the front of the tractor to the hydraulic attachment 214 by the pressure generated with hydraulic pump 204.

The hydraulic attachment 214 may be mounted to a skid steer receiver on a tractor's 100 front end loader on the front of the tractor 100.

In block 314, the hydraulic attachment 214 is operated with the pressurized fluid from the valve block 205, and returned to the valve block 205.

In block 316, hydraulic fluid returned from the hydraulic attachment 214 via the valve block 205 is cooled with a heat exchanger 212 to maintain the hydraulic fluid temperature within a predetermined range.

In block 318, the hydraulic filter contaminants are filtered by filter 213 from the hydraulic fluid cooled by the heat exchanger 212.

In block 320, the filtered fluid is deposited into the hydraulic tank.

Referring to FIG. 4, there is shown a front view of the hydraulic adapter 200. Adapter 200 is shown having a heat exchanger 402 and block valve 404.

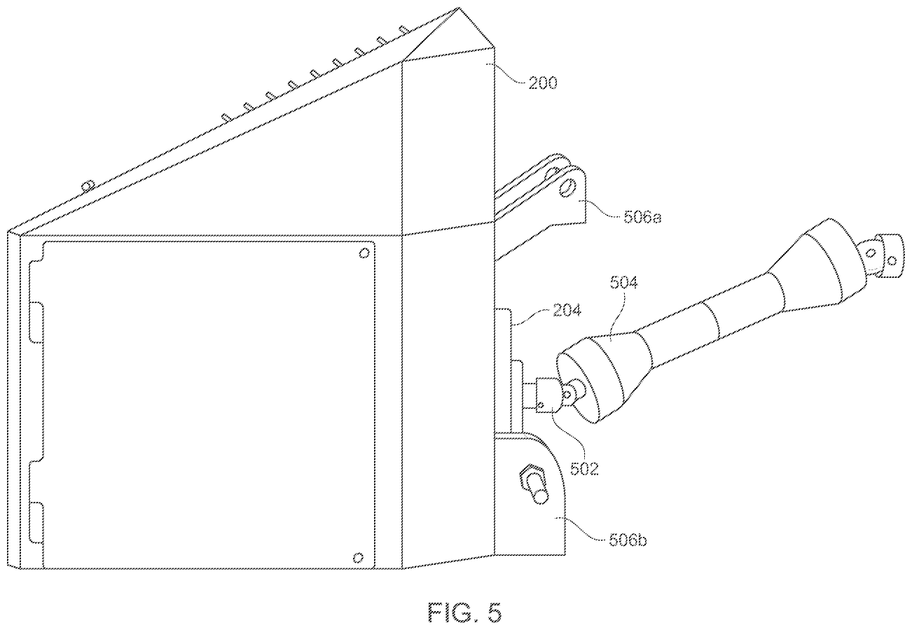

Referring to FIG. 5, there is shown a right-side view of the hydraulic adapter 200. Hydraulic adapter 200 is shown having a shaft 502 of pump 204 to connect with shaft adapter 504 to PTO of tractor 100, and brackets 506a and 506b for physically connecting hydraulic adapter 200 to the back of tractor 100 (FIG. 1).

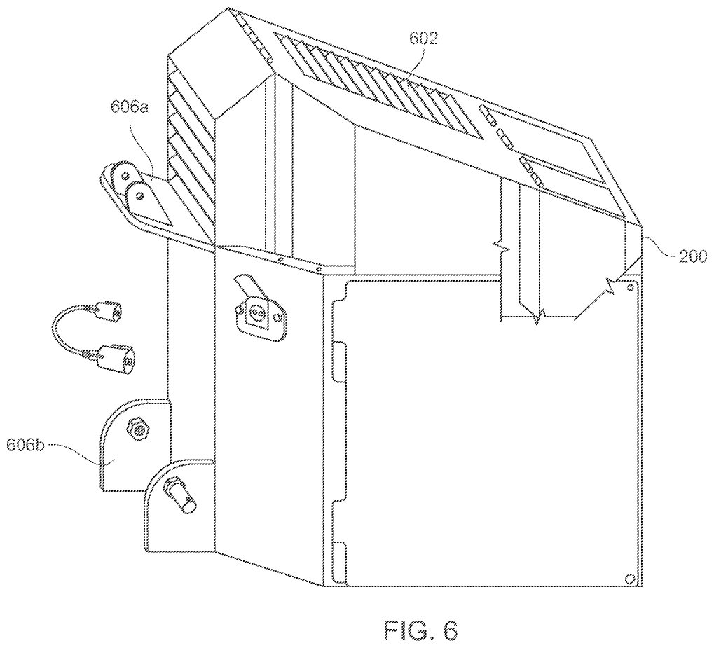

Referring to FIG. 6, there is shown a left side view of the hydraulic adapter 200. Adapter 200 is shown having brackets 606a and 606b for physically connecting adapter 200 to the back of tractor 100 (FIG. 1). Also shown are vents 602 for fan of heat exchanger 212 (FIG. 2).

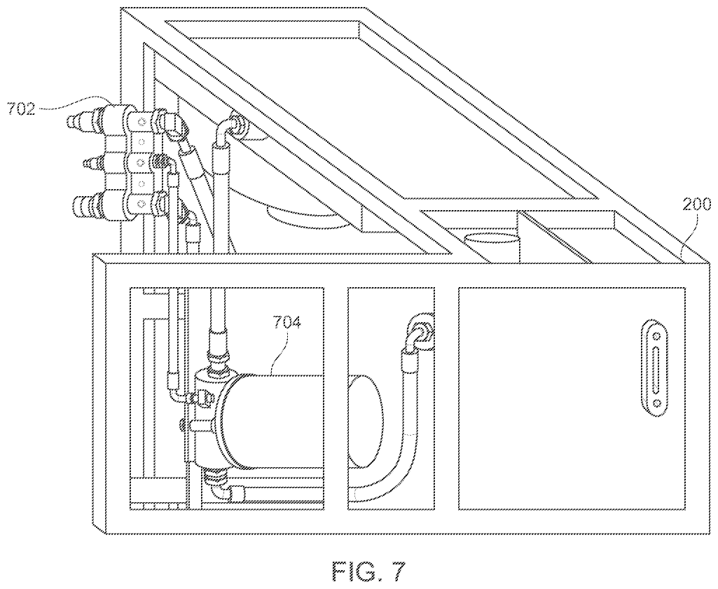

Referring to FIG. 7, there is shown a right front view of the hydraulic adapter 200 with a pressure relief 702 exposed and coupled to relief 704.

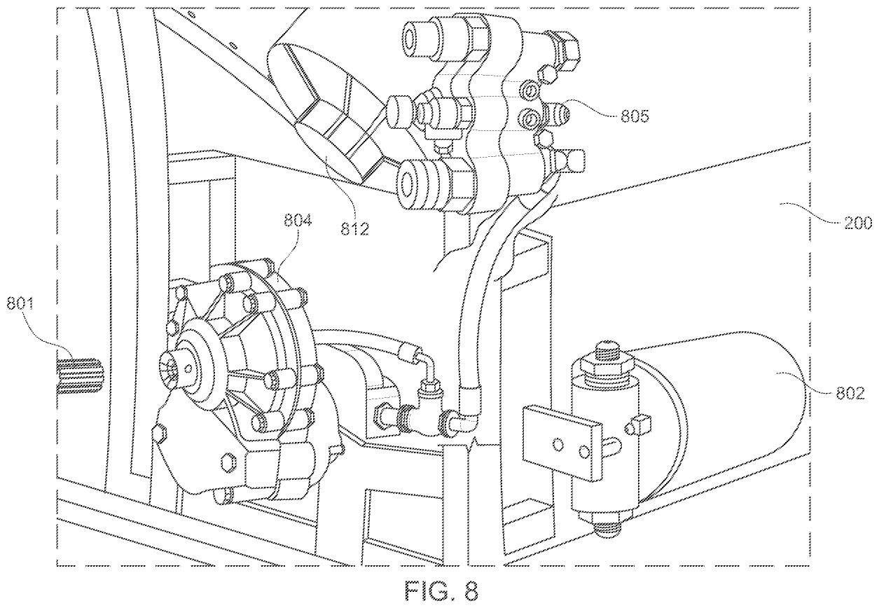

Referring to FIG. 8, there is shown a left rear view of the hydraulic adapter 200. Adapter includes with a pump 804, a Saturn valve 805, a heat exchange fan 812 and a hydraulic fluid tank 802 exposed. Adapter 200 is shown having a shaft 801 of pump 804 to connect to PTO of tractor 100.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A tractor hydraulic adaptor comprising:
a hydraulic tank operative to store hydraulic fluid;
a hydraulic pump having a pump shaft adapted to couple with a tractor power take off (PTO) shaft disposed on a rear of the tractor, the pump shaft turning in response to rotation of the tractor PTO shaft to run the hydraulic pump, the hydraulic pump to draw stored hydraulic fluid from the tank and feed via a valve block the drawn stored hydraulic fluid to a hydraulic attachment disposed on a front of the tractor;
a heat exchanger to cool hydraulic fluid returned from the hydraulic attachment via the valve block and maintain the hydraulic fluid at a temperature within a predetermined range; and
a hydraulic filter coupled to the heat exchanger and the hydraulic tank, the hydraulic filter to filter contaminants from the hydraulic fluid cooled by the heat exchanger and to deposit filtered fluid into the hydraulic tank.

2. The tractor hydraulic adaptor as recited in claim 1, wherein feed via a valve block the drawn hydraulic fluid to a hydraulic attachment disposed on a front of the tractor includes feeding the hydraulic fluid via a fluid line to at least one of an auger, a brush cutter, a trencher, a stump grinder, and a street sweeper.

3. A method for hydraulically controlling a hydraulic attachment with a hydraulic adapter powered by a tractor power take off (PTO) shaft disposed on a rear of a tractor, the method comprising:
providing within the hydraulic adapter a hydraulic intensifier pump fluidly coupled to a valve block and a hydraulic tank, a heat exchanger fluidly coupled to the valve block and coupled to the hydraulic tank via a hydraulic filter;
physically attaching the hydraulic adapter to a hitch on a rear portion of the tractor such that the PTO shaft rotatably couples with a pump shaft of the hydraulic intensifier pump;
physically connecting the hydraulic attachment to a front portion of the tractor;
fluidly coupling the hydraulic attachment to the valve block;
rotating the pump shaft in response to rotation of the PTO shaft to run the hydraulic intensifier pump,
drawing hydraulic fluid stored in the hydraulic tank and feeding via the valve block the drawn hydraulic fluid under pressure to the hydraulic attachment with the hydraulic pump;
operating the hydraulic attachment with the pressurized fluid from the valve block, and returning the fluid to the valve block;
cooling hydraulic fluid returned from the hydraulic attachment via the valve block with a heat exchanger to maintain the hydraulic fluid temperature within a predetermined range;
filtering with the hydraulic filter one or more contaminants from the hydraulic fluid cooled by the heat exchanger to create filtered fluid; and
depositing the filtered fluid into the hydraulic tank.

4. The method for hydraulically controlling a hydraulic attachment with a hydraulic adapter as recited in claim 3, wherein drawing fluid stored in the hydraulic tank and feeding via the valve block the drawn hydraulic fluid to the hydraulic attachment with the hydraulic pump comprises:
feeding via the valve block the drawn hydraulic fluid through a hydraulic fluid line extending from a back of the tractor to the front of the tractor to the hydraulic attachment with the hydraulic pump.

5. The method for hydraulically controlling a hydraulic attachment with a hydraulic adapter as recited in claim 4, wherein feeding via the valve block the drawn hydraulic fluid through a hydraulic fluid line extending from a back of the tractor to the front of the tractor to the hydraulic attachment with the hydraulic pump includes:
feeding via the valve block the drawn hydraulic fluid through a hydraulic fluid line extending from a back of the tractor to the front of the tractor to the hydraulic attachment that includes at least one of an auger, a brush cutter, a trencher, a stump grinder, and a street sweeper.

6. The method for hydraulically controlling a hydraulic attachment with a hydraulic adapter as recited in claim 5 further comprising:
mounting the hydraulic attachment to a skid steer receiver on a tractor front end loader on the front of the tractor.

7. A system comprising:
a tractor with a rear power take off (PTO) shaft and a hydraulic attachment coupled a tractor front end loader; and
a hydraulic adapter containing a hydraulic pump powered by the PTO shaft to drive the hydraulic attachment, the hydraulic power operative to draw hydraulic fluid and feed the drawn hydraulic fluid to the hydraulic attachment on a front of the tractor.

8. The system as recited in claim 7, wherein the hydraulic attachment is at least one of an auger, a brush cutter, a trencher, a stump grinder, and a street sweeper.

9. The system as recited in claim 7, wherein the hydraulic attachment is coupled to a skid steer receiver on the tractor front end loader.

10. The system as recited in claim 7, wherein the hydraulic adapter further includes a hydraulic tank operative to store hydraulic fluid, wherein the hydraulic pump has a pump shaft adapted to couple with a tractor power take off (PTO) shaft disposed on a rear of the tractor, wherein the pump shaft turns in response to rotation of the tractor PTO shaft to run the hydraulic pump, wherein the hydraulic pump is coupled with the hydraulic tank to draw stored hydraulic fluid from the tank and feed via a valve block the drawn hydraulic fluid to the hydraulic attachment; and
wherein the hydraulic adapter also includes:
a heat exchanger to cool hydraulic fluid returned from the hydraulic attachment via the valve block and maintain the hydraulic fluid temperature within a predetermined range, and
a hydraulic filter coupled to the heat exchanger and the hydraulic tank, the hydraulic filter to filter contaminants from the hydraulic fluid cooled by the heat exchanger and to deposit filtered fluid into the hydraulic tank.
